(19) United States
(12) Patent Application Publication
(10) Pub. No.: US 2026/0063833 A1
(43) Pub. Date: Mar. 5, 2026

(54) OPTICAL ELEMENT

(71) Applicant: HAYASHI TELEMPU CORPORATION, AICHI (JP)

(72) Inventor: Takeya SAKAI, Nagoya (JP)

(73) Assignee: HAYASHI TELEMPU CORPORATION, AICHI (JP)

(21) Appl. No.: 19/309,307

(22) Filed: Aug. 25, 2025

(30) Foreign Application Priority Data
Aug. 28, 2024 (JP) 2024-146531

(51) Int. Cl. G02B 5/30

(52) U.S. Cl. CPC G02B 5/3083

(57) ABSTRACT

Provided is an optical element which has a retarder layer that achieves uniform retardation despite a non-planar optical surface of the optical element and which does not require complicated steps for fabrication. The optical element 10 includes a substrate 11 having a non-planar optical surface 11a, and a retarder layer 12 on the optical surface 11a. The retarder layer 12 has a uniform retardation value throughout the layer and is composed of a single layer. The optical element 10 may lack a molecule alignment mechanism to promote retardation in the retarder layer 12.

### CROSS REFERENCE TO THE RELATED APPLICATION

This application is based on and claims priority to Japanese patent application No. 2024-146531, filed Aug. 28, 2024, the entire disclosure of which is herein incorporated by reference as a part of this application.

### BACKGROUND OF THE INVENTION

### Field of the Invention

The present invention relates to an optical element with a non-planar optical surface and a retarder layer on the optical surface.

### Description of Related Art

A recent entry among the devices for displaying images output from a computer, examples of which include liquid crystal displays (LCDs) and organic light-emitting diodes (OLEDs) that have been traditionally used, is head-mounted displays (HMDs), which are worn on the head of a user and render images that are viewed in the field of view of the user through an eyepiece. The HMDs have been developed and are increasingly available in the market as devices designed for virtual reality (VR) or augmented reality (AR), for instance. As with the traditional counterparts, a wider viewing angle and a higher contrast are desired for these new display devices for a better display quality. In head-mounted displays, the optics between the eyes of a user and the image rendering section of a display device contain elements for achieving enhanced display quality in addition to lenses, including a polarizing plate and a retardation plate.

A smaller thickness and reduction in space for the optics are needed if a head-mounted display with a reduced size and weight is to be realized. To address this need, a head-mounted display may use optics called pancake optics which can generate overlapping reflections between a plurality of optical elements to create a longer optical path. Such optics may employ a convex lens, a non-spherical lens, and/or other such optical element with a non-planar optical surface.

JP Laid-open Patent Publication No. 2022-020360 discloses an optical element that has a retarder layer with a small retardation variation and is obtained by disposing the retarder layer, which includes an alignment layer and liquid crystal layer, on a curved lens. The alignment layer is used to align the molecules in the liquid crystal layer, and a coating operation is conducted in such a way to satisfy prescribed conditions, which can be met by varying the thickness of the retarder layer on different points of the lens.

### SUMMARY OF THE INVENTION

If a retarder layer to be disposed on a non-planar lens is implemented by a retarder film, the retarder film would have to be shaped in such a way that conforms along the lens. In so doing, an issue such as disappearance of or a significant change in the retardation of the retarder film may occur due to deformation, or stress and strain, caused by heating and forming in the process. This would lead to undesired discrepancy of the retardation value of the retarder film from a target value and can result in the failure to create uniform in-plane retardation.

In the approach of JP Laid-open Patent Publication No. 2022-020360, the alignment layer and the liquid crystal layer are layered on the curved lens such that the molecules contained in the alignment layer promote, through their anchoring force, alignment of the orientations of the liquid crystal molecules in the liquid crystal layer. This results in a retarder layer having a two-layer structure composed of the alignment layer and the liquid crystal layer. The liquid crystal layer is formed in such a way that the thickness of the liquid crystal layer satisfies prescribed conditions on selected points of the curved lens, which points are defined by the directions of the slow-axis and the fast-axis of the liquid crystal layer. Yet, in this approach, complicated steps must be taken to fabricate a desired retarder film, including the steps for formation of an alignment film, impartment of anchoring force to the alignment film, coating and drying of a liquid crystal composition to form the liquid crystal layer, and adjustment of the thickness of the liquid crystal layer by means of dry etching and/or some other process on desired points of the curved lens. Thus, the drawbacks with optical elements having such a retarder layer are that they are costly to manufacture and difficult to achieve reduction in thickness because the retarder layer has to be composed of more than one layer.

An object of the present invention is to provide an optical element which can be easily fabricated and which has a retarder layer that is composed of a single layer and that achieves uniform retardation.

In order to achieve the abovementioned object, the present invention provides an optical element that includes a substrate having a non-planar optical surface, and a retarder layer on the optical surface, in which the retarder layer has a uniform retardation value throughout the layer and is composed of a single layer.

This configuration can provide for an optical element with a simplified structure to form a retarder layer having a uniform retardation value on a non-planar optical surface, and can optimize the image display quality of a display device when the display device is used with the optical element, including its viewing angle, brightness, and contrast.

The optical element can lack a molecule alignment mechanism to promote retardation in the retarder layer.

This configuration allows a non-planar optical element having a uniform retarder layer to be produced without requiring any complicated steps, by eliminating any additional features to the optical element needed to achieve molecular alignment that promotes retardation in the retarder layer.

The retarder layer of the optical element can have a thickness of 100 nm to 20,000 nm.

This configuration makes it possible to achieve a desired thickness and even allows a retarder layer with a significant thinness to be produced on the surface of a lens as necessary. Note that the thickness of the retarder layer herein refers to its thickness as measured along the normal to the optical surface where the retarder layer is located.

The retardation value of the retarder layer of the optical element can be between 100 nm and 400 nm.

This configuration can create ideal retardation (e.g., λ/4 where λ indicates the wavelength of light) for light wavelengths in the visible region and can therefore further enhance the display quality of images that are viewed through the optical element.

The optical element can further include a second retarder layer layered on the retarder layer. The second retarder layer is composed of a single layer having a uniform retardation value throughout the layer.

This configuration allows for more advantageous control of the retardation performance that may be exhibited by the optical element, thanks to the two retarder layers of the optical element, which are composed of the retarder layer formed on the optical surface of the optical element and the second retarder layer formed on the retarder layer.

The retarder layer and the second retarder layer of the optical element can have respective non-parallel optical axes.

By setting the optical axes of the retarder layer and the second retarder layer at a relative angle in a non-parallel manner, this configuration can impart advantageous retardation performance to the optical element, such as, for example, an anomalous wavelength dispersion property.

The substrate of the optical element can be in the form of a resinous lens or a glass lens.

According to this configuration, not only glass lenses but also resinous lenses that have limited solvent resistance and processing temperature can be used as the substrate, on which a photoalignable material may be coated to implement a uniform retarder layer.

The optical surface of the optical element may be convex or concave.

According to this configuration, the retarder layer can be formed on any non-planar surfaces, e.g., whether the optical element to be provided with the retarder layer is in the form of a convex lens or concave lens. Therefore, the resulting optical elements can find application in a variety of display devices.

The substrate of the optical element can include a polymer lacking optical anisotropy.

According to this configuration, the retarder layer can be used to create uniform retardation even when material of the substrate itself lacks anisotropy.

The present invention allows an optical element having a non-planar optical surface to be provided with a retarder layer that exhibits uniform retardation.

Any combination of at least two constructions, disclosed in the appended claims and/or the specification and/or the accompanying drawings should be construed as included within the scope of the present invention. In particular, any combination of two or more of the appended claims should be equally construed as included within the scope of the present invention.

### BRIEF DESCRIPTION OF THE DRAWINGS

The present invention will be more clearly understood from the following description of preferred embodiments thereof, when taken in conjunction with the accompanying drawings. However, the embodiments and the drawings are given only for the purpose of illustration and explanation, and are not to be taken as limiting the scope of the present invention in any way whatsoever, which scope is to be determined by the appended claims. In the accompanying drawings, like reference numerals are used to denote like or corresponding parts throughout the several views. In the figures,

FIG. 1 is a cross-sectional view of an optical element along its thickness in accordance with a first embodiment of the present invention,

FIG. 2 is a cross-sectional view of an optical element along its thickness in accordance with a second embodiment of the present invention,

FIG. 3 is a parallel Nicols image of an optical element prepared in Example 1, as captured by means of a polarized light microscope, and

FIG. 4 is a plot of the in-plane retardation of optical elements prepared in Examples 1 and 2 as a function of wavelength.

### DESCRIPTION OF EMBODIMENTS

What follows is a description of embodiments of the present invention, made with reference to the drawings. It should be noted that alike or corresponding features are indicated with alike symbols throughout the different figures with their discussions often omitted. Further, numerical ranges denoted using the symbol “-” or “to” herein are meant to encompass the numbers present before and after the symbol as the lower and upper boundary values.

### First Embodiment

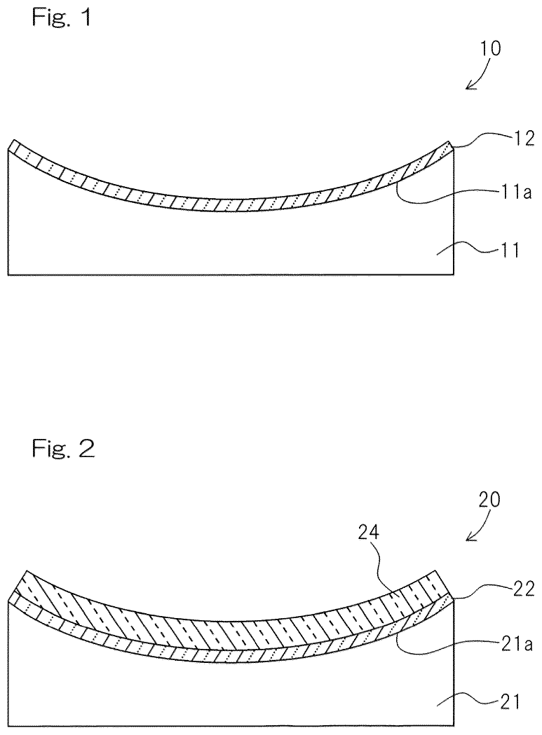

FIG. 1 shows an optical element 10 in accordance with a first embodiment of the present invention. The optical element 10 includes a substrate 11 having a non-planar optical surface 11a, and a retarder layer 12 disposed on the optical surface 11a. It should be noted that the thicknesses of different layers in FIG. 1 as well as other figures do not represent their thicknesses in reality.

In the instant embodiment, the substrate 11 is in the form of a glass lens having a non-planar, concave optical surface. Material used for the substrate 11 can be any transparent material, including: various types of glass, quartz, and other such inorganic materials; and polymethyl methacrylates, polycarbonates, norbornene-based polymers, cellulose-based polymers, polyester-based polymers, and other such organic materials. The substrate 11 may include a polymeric material lacking optical anisotropy.

The concave optical surface is merely one of the non-limiting examples of the optical surface 11a, and the substrate 11 may alternatively have a convex optical surface 11a. That is, the substrate 11 may also be in the form of a convex lens. Moreover, the substrate 11 is not limited to concave lenses or convex lenses and may assume any form as long as it has a non-planar optical surface 11a.

The retarder layer 12 disposed on the optical surface 11a of the substrate 11 of the optical element 10 includes a photoalignable material. By irradiating polarized light onto the retarder layer 12, the photoalignable material can be induced to align its molecules in such away to develop retardation. In this way, the retarder layer 12 can acquire its retardation function. More particularly, the retarder layer 12 can acquire a retardation function that is exhibited substantially uniformly throughout the layer.

Photoalignable material in the context of the present invention refers to a material that can be induced to align its molecules on the basis of molecular mobilization that occurs in response to light irradiation (or, preferably, the combination of light irradiation and a heating and cooling treatment). Axis-selective birefringence can additionally be induced in such a photoalignable material, when it is being induced to align its molecules. Based on this property, a photoalignable material will often be referred to as a birefringence-inducible material below.

For instance, the birefringence-inducible material may include a liquid crystalline polymer having a side chain structure containing a photosensitive group and capable of forming a liquid crystal structure, whereby photoreaction of the photosensitive group present on a side chain can induce the alignment of its molecules. Examples of the photoreaction include photodimerization reaction, photoisomerization reaction, and photo-Fries rearrangement reaction.

For the liquid crystalline polymer capable of forming a liquid crystal structure, its liquid crystalline nature can be expressed through the presence, on its side chain structure, of a rigid mesogenic group that exhibits liquid crystalline properties. The liquid crystalline property can also be exhibited by a structure capable of forming a dimer via a hydrogen bond with a side chain on another polymer of a different kind or the same kind such that the dimerization results in the formation of a mesogenic structure.

The mesogenic group or mesogenic structure is constituted by two or more aromatic or aliphatic rings and a linking group that connects the rings. The linking group may be in the form of a covalent bond or hydrogen bond.

Examples of the aromatic rings include: a benzene ring; a naphthalene ring; and a heterocyclic ring (e.g., oxygen-containing heterocyclic rings such as a furan ring and a pyran ring, and nitrogen-containing heterocyclic rings such as a pyrrole ring and an imidazole ring). Examples of the aliphatic rings include a cyclohexane ring. It should be understood that these aromatic rings or aliphatic rings may be optionally substituted with a substituent. Examples of the substituent include: an alkyl group (e.g., a C1 to C6 alkyl group and, preferably, a C1 to C4 alkyl group); an alkyloxy group (e.g., a C1 to C6 alkyloxy group and, preferably, a C1 to C4 alkyloxy group); an alkenyl group (e.g., a C1 to C6 alkenyl group and, preferably, a C1 to C4 alkenyl group); an alkynyl group (e.g., a C1 to C6 alkynyl group and, preferably, a C1 to C4 alkynyl group); and a halogen atom. Examples of the linking group for the covalent bond include: a single bond; —O—; —COO—; —OCO—; —N═N—; —NO═N—; —C═C—; —C≡C—; —CO—C═C—; —CH═N—; and alkylene group. Examples of the linking group for the hydrogen bond include a side chain structure having, on its end, a carboxylic group which forms a hydrogen bond with another carboxylic group.

The photosensitive group can be any functional group capable of causing photoreaction by exposure to light energy, including, for example: a chalcone group; a coumarin group; a cinnamoyl group; a cinnamic acid group; a cinnamylideneacetic group; a biphenylacryloyl group; a furylacryloyl group; a naphthylacryloyl group; an azobenzene group; a benzylideneaniline group; and derivatives thereof. Preferred thereamong may be a cinnamoyl group.

A repeating unit for the liquid crystalline polymer can include at least a side chain structure containing both a photosensitive group and a structure capable of forming a liquid crystal structure. The photosensitive group may be present independently of the mesogenic group or mesogenic structure within the side chain structure, or may share a chemical structure and exist compositely with the mesogenic group or mesogenic structure.

A birefringence-inducible material according to the present invention may include a liquid crystalline polymer having at least one structure selected from the group consisting of the side chain structures represented by the following formulae (1) and (2):

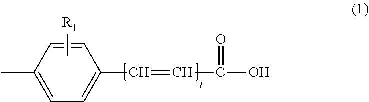

where t indicates an integer between 1 and 3, and R1 indicates one or more members selected from the group consisting of: a hydrogen atom; an alkyl group (e.g., a C1 to C6 alkyl group and, preferably, a C1 to C4 alkyl group); an alkyloxy group (e.g., a C1 to C6 alkyloxy group and, preferably, a C1 to C4 alkyloxy group); an alkenyl group (e.g., a C1 to C6 alkenyl group and, preferably, a C1 to C4 alkenyl group); an alkynyl group (e.g., a C1 to C6 alkynyl group and, preferably, a C1 to C4 alkynyl group); and a halogen atom; and

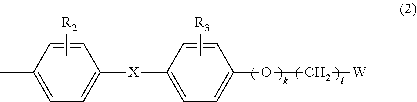

where k indicates 0 or 1, 1 indicates 0 when k is 0 and indicates an integer between 1 and 12 when k is 1, X indicates a single bond, a C1 to C3 alkylene group, —C═C—, —C≡C—, —O—, —N═N—, —COO—, or —OCO—, W indicates a coumarin group, a cinnamoyl group, a cinnamylideneacetyl group, a biphenylacryloyl group, a furylacryloyl group, a naphthylacryloyl group, or any derivative group thereof, and R2 and R3 may be the same or different and each indicate one or more members selected from the group consisting of: a hydrogen atom; an alkyl group (e.g., a C1 to C6 alkyl group and, preferably, a C1 to C4 alkyl group); an alkyloxy group (e.g., a C1 to C6 alkyloxy group and, preferably, a C1 to C4 alkyloxy group); an alkenyl group (e.g., a C1 to C6 alkenyl group and, preferably, a C1 to C4 alkenyl group); an alkynyl group (e.g., a C1 to C6 alkynyl group and, preferably, a C1 to C4 alkynyl group); a carboxyl group; and a halogen atom.

It should be noted that the side chain structures represented by the above formulae (1) and (2) indicate the chemical structure of an end of a side chain in a repeating unit and that a variety of chemical structures may be incorporated between such a side chain structure and the backbone structure to the extent that does not impair advantageous effects of the present invention.

The liquid crystalline polymer may be in the form of a homopolymer of a single repeating unit that includes one of the aforementioned side chain structures, or a copolymer of a repeating unit that includes one of the aforementioned side chain structures and a further repeating unit that includes a side chain structure different therefrom. The backbone structure can be formed by polymerization of a hydrocarbon, an acrylate, a methacrylate, a siloxane, a maleimide, and/or a N-phenylmaleimide, among others.

When in the form of a copolymer, the liquid crystalline polymer may have a repeating unit that lacks a photosensitive group and/or a structure capable of forming a liquid crystal structure.

A birefringence-inducible material according to the present invention may also include, in addition to the liquid crystalline polymer, a small-molecule compound to facilitate the side chain alignment of the liquid crystalline polymer. Preferred species of the small-molecule compound that can be used exhibit liquid crystalline properties by containing a substituent, such as a biphenyl, terphenyl, phenylbenzoate, and azobenzene group, that is known to be a mesogenic component, a functional group such as an allyl, acrylate, methacrylate, and cinnamic acid group (or derivative groups thereof), and a spacer (e.g., an (oxy-)alkylene group having 1 to 15 carbons (preferably, 1 to 10 carbons and, more preferably, 1 to 5 carbons)) linking the substituent and the functional group. These species of the small-molecule compound may be used independently or in combination.

The retarder layer 12 is applied and formed as a coating film on the substrate 11. For this, the birefringence-inducible material described above is dissolved in a solvent to prepare a solution which, in turn, is applied onto the substrate. The solvent can be selected, as appropriate, according to the type of the birefringence-inducible material. Examples of the solvent include dioxane, dichloroethane, cyclohexanone, toluene, tetrahydrofuran, o-dichlorobenzene, methyl ethyl ketone, methyl isobutyl ketone, an ethylene glycol derivative (e.g., an ethylene glycol monoethyl ether and a diethylene glycol monoethyl ether), and a propylene glycol derivative (e.g., a propylene glycol monomethyl ether and propylene glycol 1-monomethyl ether 2-acetate). These solvents may be used independently or in combination.

The solvent may comprise the birefringence-inducible material at any concentration, but can comprise, for example, 5-50 wt %, preferably 8-40 wt %, and more preferably 10-25 wt % of the birefringence-inducible material. A known coating technique such as, for example, spin-coating and roll-coating can be used to apply the solution to the substrate.

If necessary, following the coating, the coating film may be dried through heating. The concentration of the coating solution can be adjusted to achieve a uniform thickness of the coating film. The orientation and attitude of the substrate may be changed over time during the drying step, to account for the viscosity of the solution with the adjusted concentration.

Next, the retarder layer 12 is irradiated with polarized light to develop retardation. This is done to selectively trigger photoreaction of molecules and induce alignment of the molecules, on the surface of and within the retarder layer 12. In the instant embodiment, polarized light can directly hit the retarder layer 12 of the optical element 10 without passing through an intervening layer. This allows molecular alignment having a desired retardation value to be induced by the irradiation of the polarized light.

Examples of the polarized light used to irradiate the retarder layer 12 include infrared light, visible light, ultraviolet light (e.g., near-ultraviolet light and far-ultraviolet light), X-ray, charged particle beam (e.g., electron beam), or any other light having a wavelength that triggers photoreaction of the photosensitive group on the liquid crystalline polymer. The wavelength of the light may vary depending on the type of the side chain structure of the liquid crystalline structure, but can be in the range of 200-500 nm. For instance, the polarized light for irradiation may be in the form of linearly-polarized ultraviolet light. For example, in this case, an ultraviolet radiation device such as a high-pressure mercury vapor lamp may be used as a light source and combined with a Glan-Taylor prism for polarization conversion to create the linearly-polarized light.

Moreover, with a view to triggering alignment not only on the surface but also within the retarder layer, the irradiation dose of the polarized light can be, for example, 10 mJ/cm² to 10 J/cm², preferably 50 mJ/cm² to 1 J/cm², and more preferably 100 mJ/cm² to 500 mJ/cm².

The direction of propagation of the polarized light used for irradiation may be collimated, e.g., vertical when viewed in FIG. 1, relative to the retarder layer 12. A lens may also be positioned on the irradiation path to modulate the collimated irradiation light into optical paths with varying directions to irradiate different points on the non-planar optical surface 11a from different directions. If the retarder layer 12 is to be formed on a concave curved optical surface 11a as shown in FIG. 1, a lens with upward convexity can be positioned on the incident side of the retarder layer 12 as viewed in FIG. 1 to irradiate different points of the optical surface 11a with the polarized light in the respective directions of propagation that are substantially parallel to the normal thereto. In this way, the retarder layer 12 can attain a more uniform in-plane retardation value.

If necessary, the process for forming the retarder layer 12 may involve a heating operation to heat the applied retarder layer subsequent to the step for irradiation of the polarized light. The step for irradiation of the polarized light induces molecules to be aligned in dependence of the directions of irradiation and oscillation of the polarized light, with the aligned molecules also guiding the alignment of non-aligned molecules. The subsequent heating enables the liquid crystalline polymer to mobilize its molecules to encourage the non-aligned molecules into alignment. In one example, the heated article may be cooled down to about an ambient temperature by just being left to stand.

The heating operation can use any heating temperature as long as it mobilizes and induces the non-aligned molecules to be aligned along the liquid crystalline polymer side chains on which the photoreaction has taken place. Preferably, the temperature is set between the liquid crystal phase transition temperature and the isotropic phase transition temperature of the birefringence-inducible material. For example, the temperature can be between 10° and 200° C., preferably between 11° and 180° C., and more preferably between 12° and 160° C.

Further, any heating duration may be employed as long as it mobilizes and induces the non-aligned molecules to be aligned along the liquid crystalline polymer side chains on which the photoreaction has taken place. The heating duration can be set as appropriate and according to the type of the liquid crystalline polymer and the heating temperature, among others, and can be, for example, one minute or longer, preferably, three minutes or longer, and more preferably five minutes or longer. The upper limit of the heating duration may be any value, and can be about 60 minutes (preferably about 40 minutes and more preferably about 30 minutes) from an economic standpoint.

The resulting retarder layer 12 exhibits in-plane retardation that is substantially uniform and can have a retardation value Re (at a measurement wavelength of 550 nm) of between 100 nm and 440 nm. Further, the optical element 10 can develop its retardation ability with the single retarder layer 12 formed thereon, without an alignment layer separate from the layer composed of liquid crystal molecules to induce the alignment of the liquid crystal molecules to develop retardation. The single retarder layer can be formed to have a thickness of 100 nm to 20,000 nm through coating, thereby making it possible to create optics with a minute thickness. Furthermore, the optical element can be easily manufactured at a low cost because it does not need complicated steps unlike those optical elements that have a retarder layer which is obtained by disposing a liquid crystal layer formed of, for example, polymerizable liquid crystals on an alignment film or other such alignment layer that facilitates alignment of the liquid crystal molecules.

In addition, the retarder layer 12 is directly formed on the substrate 11 of the optical element 10 of the instant embodiment and therefore does not require an adhesive layer unlike those configurations involving affixation of a retarder film. Therefore, optical designs that do not require an adhesive layer to be taken into account can be implemented while at the same time contributing to reduction in thickness.

### Second Embodiment

FIG. 2 shows an optical element 20 in accordance with a second embodiment of the present invention. The optical element 20 includes a substrate 21 having a non-planar optical surface 21a, a retarder layer 22 disposed on the optical surface 21a, and a second retarder layer 24 disposed on the retarder layer 22. The optical element 20 in the instant embodiment differs from the optical element 10 in the first embodiment by having the second retarder layer 24, and can even be implemented using the optical element 10 of the first embodiment by additionally forming the second retarder layer 24 on top of the retarder layer 12. To make clear distinction from the second retarder layer 24, the retarder layer 22 on which the second retarder layer 24 is layered is also called a first retarder layer 22 below.

The material and procedure for forming the retarder layer 12 in the first embodiment can also be applied to the first retarder layer 22. Nevertheless, in the instant embodiment, a birefringence-inducible material used to fabricate the first retarder layer 22 may include a liquid crystalline polymer that has a side chain structure containing a cross-linkable functional group when the polymerizable liquid crystal material includes a cross linking group, with a view to improving the adhesion between the first retarder layer 22 and the second retarder layer 24. The cross-linkable functional group can be any functional group as long as it causes a cross-linking reaction with a cross linking group which will be further described later. Examples of the cross-linkable functional group include a hydroxyl group, a carboxylic group, an amino group, and a thiol group. The side chain structure containing the cross-linkable functional group may be included in a repeating unit which also includes the previously discussed side chain structure containing a photosensitive group and capable of forming a liquid crystal structure. The cross-linkable functional group may be included in a different repeating unit.

Preferred examples of the cross-linkable functional group are a hydroxyl group and a carboxylic group. The liquid crystalline polymer may include at least one structure selected from the group consisting of —(CH₂)ₙ—OH and -Ph-COOH, where n indicates an integer between 1 and 6 and Ph indicates a phenylene group, as the side chain structure containing the cross-linkable functional group. It should be understood that these side chain structures represent at least a part of the chemical structure of a side chain in a repeating unit and any type of chemical structure may be incorporated between such a side chain structure and the backbone structure to the extent that does not impair advantageous effects of the present invention.

The second retarder layer 24 may be formed using material and procedure that are analogous in general to those for the first retarder layer 22. The thickness of the second retarder layer 24 may be identical to or different from the thickness of the first retarder layer 22. During the step for irradiation of polarized light to form the second retarder layer 24, polarized light oriented in a polarization direction different from that of the polarized light irradiated onto the first retarder layer 22 may be irradiated such that the first retarder layer 22 and the second retarder layer 24 have optical axes that are oriented differently, that is, oriented in non-parallel manner. This can result in the first retarder layer 22 and the second retarder layer 24 cooperating to exhibit retardation performance having an anomalous wavelength dispersion property for incident light over a wide wavelength band region.

### EXAMPLES

The present invention will be further described in detail with the aid of the following examples, which are not intended to limit the present invention in any way.

### Monomer 1

A mixture of p-coumaric acid and 6-chloro-1-hexanol was heated under alkaline conditions to synthesize 4-(6-hydroxyhexyloxy)cinnamic acid. This product was esterified by adding a large excess of methacrylic acid in the presence of p-toluene sulphonic acid to synthesize monomer 1 represented by the following chemical formula:

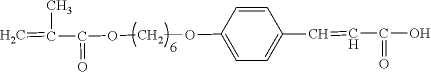

### Monomer 2

A mixture of 4-hydroxybenzoic acid and 6-chloro-1-hexanol was heated under alkaline conditions to synthesize 4-(6-hydroxyhexyloxy)benzoic acid. This product was subsequently esterified by adding a large excess of methacrylic acid in the presence of p-toluene sulphonic acid to synthesize monomer 2 represented by the following chemical formula:

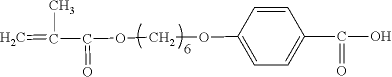

### Copolymer 1

Monomers 1 and 2 were dissolved in dioxane at a mole ratio (monomer 1:monomer 2) of 3:7. AIBN (azobisisobutyronitrile) was added as an initiator to the solution, which was then kept at 70° C. for 24 hours for polymerization to obtain copolymer 1. Copolymer 1 exhibited liquid crystalline properties.

In the following Examples and Comparative Examples, AxoScan, a birefringence measurement instrument commercially available from Axometrics, Inc., and F20, a film thickness measurement instrument commercially available from Filmetrics, Inc., were used to respectively measure the optical properties (e.g., a retardation value Re) and thicknesses of obtained optical laminates.

### Example 1

Copolymer 1 was dissolved at 25 wt % in a solvent comprising diglyme and dimethoxyethane at a ratio (diglyme:dimethoxyethane) of 2.5:1. The solution was applied onto a concave optical surface of a concave lens by using a spin coater to form a thickness of 4.3 μm, and thereafter dried at 25° C. Ultraviolet light from a high-pressure mercury vapor lamp was converted using a Glan-Taylor prism into polarized light having linear polarization, which, in turn, was irradiated onto the dried coating film at an irradiation dose of 500 mJ/cm² from a direction parallel to the normal to the centroid of the concave optical surface. Then, the resultant was heated at 130° C. for 15 minutes and cooled down to an ambient temperature to induce alignment and develop retardation in the layer formed of the coating film to make a retarder layer. From this procedure, an optical element according to the present invention was obtained.

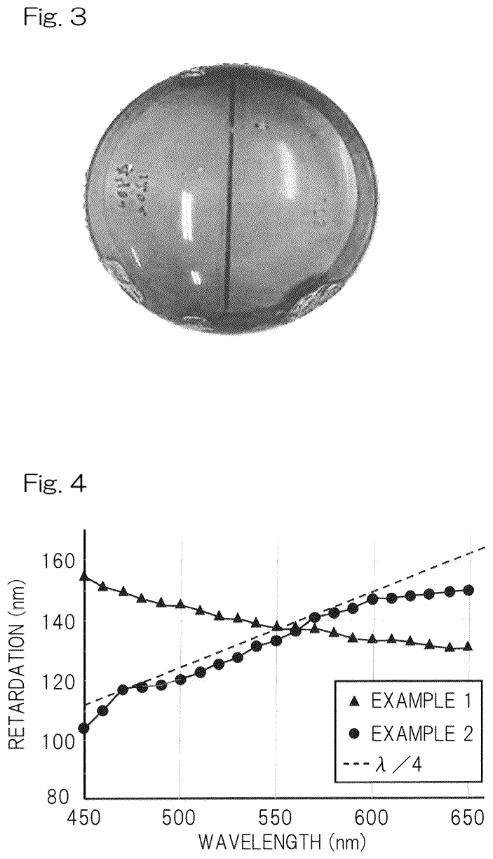

The retarder layer on the obtained optical element had an in-plane retardation value of 140.5 nm at 550 nm. FIG. 3 shows a parallel Nicols image of the above optical element as captured by means of a polarized light microscope. As shown in FIG. 3, the substantially uniform intensity of transmitted light was observed throughout the entire optical surface. Thus, it was confirmed that the retarder layer formed on the optical element which was prepared in the instant Example exhibited uniform retardation throughout the entire non-planar optical surface.

### Example 2

Copolymer 1 was dissolved at 25 wt % in a solvent comprising diglyme and dimethoxyethane at a ratio (diglyme:dimethoxyethane) of 2.5:1. The solution was applied onto the retarder layer (i.e., the first retarder layer) formed on the optical element obtained with the procedure of Example 1 by using a spin coater to form a thickness of 8.7 μm, and thereafter dried at 25° C. Ultraviolet light from a high-pressure mercury vapor lamp was converted using a Glan-Taylor prism into polarized light having linear polarization oriented with a polarizing axis at 30 degrees to that of the polarized light used for irradiation in Example 1, and the polarized light was irradiated onto the dried coating film at an irradiation dose of 500 mJ/cm² from a direction parallel to the normal to the centroid of the concave optical surface. Then, the resultant was heated at 130° C. for 15 minutes and cooled down to an ambient temperature to induce alignment and develop retardation in the layer applied as a coating film in the instant Example to make a second retarder layer. From this procedure, an optical element according to the present invention was obtained. Since polarized lights oriented with different polarizing axes were respectively irradiated to form the first and second retarder layers, these retarder layers had respective non-parallel optical axes.

FIG. 4 shows the in-plane retardations of Examples 1 and 2 as a function of wavelength in a visible light region (between 450 and 650 nm). Here, polarized light having a polarizing axis at an angle of 45 degrees to the optical axis orientation of the retarder layer was used as the incident light for a sample in Example 1, whereas polarized light having a polarizing axis at an angle of 20 degrees to the optical axis orientation of the second retarder layer was used as the incident light for a sample in Example 2. While the sample from Example 1 exhibited a normal wavelength dispersion property over the wavelengths used for the measurement, the sample from Example 2 was observed to exhibit an anomalous wavelength dispersion property over the same wavelengths: the level of retardation decreased for light with a shorter measurement wavelength. It was also confirmed that the retardation performance of the latter sample approximated that of the λ/4.

### Third Embodiment

Optical elements according to the present invention are not only applicable to the pancake optics of a head-mounted display illustrated as an example in the background section, but can also find wide application as optical elements having non-planar optical surfaces in general.

For example, a retarder layer may be disposed on the surface of a lens to provide an optical element for a projector that projects images, and define retardation that depolarizes light as it travels through the lens.

In projectors, polarized laser used as a light source can be a reason for brightness variation or color unevenness, by causing uneven light distribution in a phosphor exciting section of the light source or in the illumination optics for the image being projected. In the conventional art, a depolarizer element is often used to mitigate the uneven light distribution or color unevenness. By adopting an optical element according to the present invention for a curved lens of such projectors, the need for a separate depolarizer element can be eliminated, thereby promoting a reduced device size and manufacturing cost.

To create such an optical element, the retarder layer should define a lattice-like optical structure which includes a periodic pattern of substantially rectilinear segments arranged at uniform intervals with optical axes oriented in a prescribed direction and intervening sections therebetween with optical axes successively rotated towards the lattice vector orientation of the lattice-like optical structure. More specifically, as part of the step for irradiation of polarized ultraviolet light to induce alignment in a retarder layer, right-handed circularly-polarized and left-handed circularly-polarized ultraviolet lights can be irradiated onto the retarder layer to expose it to two-beam interference light that produces and fixates such alignment that the retarder layer includes optical axes which are successively rotated towards the lattice vector orientation, whereby an optically anisotropic structure with a uniform level of birefringence is imparted to the retarder layer.

A more particular procedure for creating such a retarder layer will be described below:

Copolymer 1 and a cinnamic acid were dissolved in tetrahydrofuran (THF) at a weight ratio of 95:5 to prepare a solution. The solution was applied onto a substrate of an optical element by using a spin coater to form a thickness of 3 μm, and thereafter dried at 25° C. Interference light exposure optics were used to transform ultraviolet laser light at 360 nm emitted from a DPSS laser, which was used as a light source, into left-handed circularly-polarized and right-handed circularly-polarized lights and to expose the dried coating film to their interference light at an irradiation dose of 200 mJ/cm². Then, the resultant was heated at 130° C. for 3 minutes and cooled down to an ambient temperature to induce alignment. The alignment resulted from: axis-selective photoreaction and formation of side chains in the coating film in accordance with the polarization direction of the interference light to which individual regions were exposed; and subsequent reorientation of non-reacted side chains along the side chains formed by the reactions, through molecular mobilization triggered by the heating. The resulting coating film had optical axes that were oriented to be successively rotated towards the lattice vector orientation. From this procedure, an optical element according to the present invention was obtained.

It should be understood that any procedures different from the above can be employed as long as they impart such periodic patterns of alignment to a liquid crystalline material that exhibits photoalignability.

As an alternative to irradiation of polarized ultraviolet light onto a photoalignable material, the retarder layer to be made on a non-planar optical surface of a substrate may be formed by setting an annealed retarder film on the optical surface.

As mentioned earlier, if a retarder layer on a non-planar lens is to be implemented by a retarder film, the retarder film would have to be stretched, and set and affixed in such a way that conforms along the lens. In so doing, the retardation of the retarder film may disappear or change significantly due to deformation, or stress and strain, caused by the heating and forming in the process. Hence, an issue may occur such as undesirable discrepancy of the retardation value of the retarder film from a target value and the failure to create uniform in-plane retardation.

To address this issue, research and studies were conducted on retarder films in which the molecules of polymerizable liquid crystals have been aligned and fixated and retarder films in which photosensitive, birefringence-inducible material has been aligned and fixated, among others, to use them as formable retarder films. While disappearance of retardation was prevented from happening, these formable retarder films could not address the problem of retardation drop. In another approach, it was tried to perform a heat treatment on a retarder film fabricated on a glass substrate or PET film substrate in order to cause retardation drop in advance, before it would take place through relaxation of molecular orientation that occurs at the time of forming and heating. Yet, reduction in the retardation was still observed at the time of film shaping.

As a solution to this problem, the Applicant found that subjecting a retarder film exhibiting retardation to an annealing treatment at a prescribed temperature and at a prescribed point in time before shaping and forming the retarder film onto a non-planar optical surface prevented disappearance or reduction of the retardation at the time of the subsequent shaping and forming of the retarder film to make a retarder layer on the optical surface.

### Example of Annealing Treatment for Retarder Film

A particular example of an annealing treatment for a retarder film will be described below:

### 1. Preparation of Retarder Film

Firstly, a retarder film exhibiting retardation is prepared. The preparation of the retarder film can involve: application of a 3 wt % solution of a photoalignable material 750025, which is commercially available from Hayashi Telempu Corporation, in a PGM (propylene glycol monomethyl ether) onto a glass substrate; irradiation of polarized ultraviolet light (at 20 mJ/cm²); application of a solution of a 19 wt % polymerizable liquid crystal compound Paliocolor LC242, which is commercially available from BASF Japan Ltd., and a 1 wt % photopolymerization initiator Irgacure 907, which is commercially available from Ciba Specialty Chemicals Inc., in PGMEA (propylene glycol 1-monomethyl ether 2-acetate) on the resultant; heating to 90° C. and cooling down to an ambient temperature to induce alignment; and subsequent irradiation of non-polarized ultraviolet light (at 200 mJ/cm²) to cross-link the polymerizable liquid crystal compound.

The resulting retarder film had an in-plane retardation value of 150 nm at 550 nm.

### 2. Assembly of Retarder Film

Then, the retarder film was transferred to a TAC film (triacetyl cellulose film). Further, a pressure-sensitive adhesive with a separator was applied onto the retarder film such that the latter was sandwiched between the pressure-sensitive adhesive and the TAC film.

### 3. Annealing Treatment

An annealing treatment was conducted by heating the film for 10 minutes in a constant-temperature oven at 120° C. At this point, the retardation value of the film was measured to be 136 nm at 550 nm.

4. Forming onto Non-planar Optical Surface

After the removal of the separator, the resulting retarder film was shaped and affixed onto a spherical lens (R=50) through pressure forming. The retarder film, when shaped onto the lens, had a retardation value of around 136 nm at 550 nm on any in-plane points of the shaped surface, confirming that the pre-shaping/forming retardation was preserved.

### COMPARATIVE EXAMPLES

A film was prepared by following the procedure in the above example of an annealing treatment for a retarder film, except the annealing treatment itself. When shaped and affixed onto a spherical lens (R=50) through pressure forming just like the above example, the film showed a retardation drop as well as considerable in-plane variation.

This confirmed that, among the steps provided in the above example, an annealing treatment is crucial to form a homogeneous retarder layer on a non-planar optical surface of an optical element.

While the above example employed a liquid crystal aligning film in which molecules were aligned through the irradiation of ultraviolet light, a different method may be used to promote the molecular alignment of molecules constituting the film. For example, rubbing may be used in the making of the aligning film.

Although the present invention has been fully described in connection with the preferred embodiments thereof with reference to the accompanying drawings which are used only for the purpose of illustration, those skilled in the art will readily conceive numerous changes and modifications within the framework of obviousness upon the reading of the specification herein presented of the present invention. Accordingly, such changes and modifications are, unless they depart from the scope of the present invention as delivered from the claims annexed hereto, to be construed as included therein.

### REFERENCE NUMERALS

10, 20 . . . optical element
11,21 . . . substrate
12, 22 . . . retarder layer (first retarder layer)
24 . . . second retarder layer

What is claimed is:

1. An optical element comprising:
a substrate having a non-planar optical surface; and
a retarder layer on the optical surface, the retarder layer having a uniform retardation value throughout the layer and being composed of a single layer.

2. The optical element as claimed in claim 1, wherein the optical element lacks a molecule alignment mechanism to promote retardation in the retarder layer.

3. The optical element as claimed in claim 1, wherein the retarder layer has a thickness of 100 nm to 20,000 nm.

4. The optical element as claimed in claim 1, wherein the retardation value of the retarder layer is between 100 nm and 400 nm.

5. The optical element as claimed in claim 1, further comprising:
a second retarder layer layered on the retarder layer and composed of a single layer having a uniform retardation value throughout the layer.

6. The optical element as claimed in claim 5, wherein the retarder layer and the second retarder layer have respective non-parallel optical axes.

7. The optical element as claimed in claim 1, wherein the substrate comprises a resinous lens or a glass lens.

8. The optical element as claimed in claim 1, wherein the optical surface is convex or concave.

9. The optical element as claimed in claim 1, wherein the substrate comprises a polymer lacking optical anisotropy.
